(19) United States
(12) Patent Application Publication
(10) Pub. No.: US 2011/0156612 A1
(43) Pub. Date: Jun. 30, 2011

(54) LED DRIVE CIRCUIT, PHASE CONTROL DIMMER, LED ILLUMINATION FIXTURE, LED ILLUMINATION DEVICE, AND LED ILLUMINATION SYSTEM

(75) Inventors: Atsushi Kanamori, Osaka-shi (JP); Masaru Kubo, Osaka-shi (JP); Yasuhiro Maruyama, Osaka-shi (JP); Hirohisa Warita, Osaka-shi (JP)

(73) Assignee: SHARP KABUSHIKI KAISHA, Osaka-shi (JP)

(21) Appl. No.: 12/871,572

(22) Filed: Aug. 30, 2010

(30) Foreign Application Priority Data
Dec. 25, 2009 (JP) 2009-295028

(51) Int. Cl. H05B 37/02

(52) U.S. Cl. 315/291

(57) ABSTRACT

An LED drive circuit for driving an LED by input of an alternating voltage, the LED drive circuit being capable of connecting to a phase control dimmer. The LED drive circuit is provided with a current extractor for continuing to allow current to flow into the phase control dimmer so that a phase control element inside the phase control dimmer does not switch off before the alternating voltage reaches 0 V after the phase control element inside the phase control dimmer switches on and the LED emits light.

This nonprovisional application claims priority under 35 U.S.C. §119(a) on Patent Application No. 2009-295028 filed in Japan on Dec. 25, 2009, the entire contents of which are hereby incorporated by reference.

### BACKGROUND OF THE INVENTION

1. Field of the Invention

The present invention relates to an LED drive circuit for driving an LED (Light Emitting Diode), to a phase control dimmer which can be connected to the LED drive circuit, and to an LED illumination fixture, LED illumination device, and LED illumination system having an LED as a light source.

2. Description of the Related Art

An LED has such characteristics as low current consumption and long service life, and LED applications are expanding not only to display devices but also to illumination fixtures and other applications. In LED illumination fixtures, a plurality of LED units is often used in order to obtain the desired lighting intensity.

Common illumination fixtures usually use a commercial AC 100 V power supply, and in cases in which an LED illumination fixture is used in place of an incandescent bulb or other common illumination fixture, it is preferred that the LED illumination fixture also be configured to use a commercial AC 100 V power supply, the same as a common illumination fixture.

In the case of applying dimmer control to an incandescent bulb, a phase control dimmer (commonly referred to as an incandescent light control) is used in which dimmer control can easily be applied to the supply of power to the incandescent bulb by a single volume element, by switching on a switching element (usually a thyristor element or triac element) at a certain phase angle of an alternating-current power supply voltage. However, in cases in which an incandescent bulb is dimmed by a phase control dimmer, flickering or blinking is known to occur, and normal dimming is not possible when a low-wattage incandescent bulb is connected to the dimmer.

The same type of phase control dimmer used for dimmer control of an incandescent bulb is preferably used in cases in which dimmer control is applied to an LED illumination fixture that uses an alternating-current power supply. FIGS. 17 and 18 show examples of conventional LED illumination systems whereby dimmer control can be applied to an LED illumination fixture that uses an alternating-current power supply.

The LED illumination system shown in FIG. 17 is provided with a phase control dimmer 2, an LED drive circuit having a diode bridge DB1 and a current limiting circuit 5, and an LED module 3. The phase control dimmer 2 is connected in series between an alternating-current power supply 1 and the LED drive circuit. In the phase control dimmer 2, when the knob (not shown in the drawing) of a semi-fixed resistor Rvar1 is set to a certain position, a triac Tri1 is switched on at a power supply phase angle corresponding to the set position. A noise prevention circuit using a capacitor C1 and an inductor L1 is also provided in the phase control dimmer 2, and terminal noise returning to the power supply line from the phase control dimmer 2 is reduced by the noise prevention circuit.

The LED illumination system shown in FIG. 18 is provided with a phase control dimmer 2, an LED module 3, and an LED drive circuit which has a diode bridge DB1, a switching control circuit CNT1, a switching element Q1, a coil L2, a diode D1, a capacitor C4, and a resistor R2. In the LED illumination system shown in FIG. 18, the switching control circuit CNT1 detects the value of the current flowing to the resistor R2 and the root-mean-square value of the voltage that occurs at the positive output terminal of the diode bridge DB1, and controls the on/off state of the switching element Q2 on the basis of these detection results.

FIG. 20 shows an example of the voltage and current waveform of each component when an incandescent bulb 13 is operated by the phase control dimmer 2 (see FIG. 19). FIG. 20 shows the waveform of the output voltage V₁ of the alternating-current power supply 1, the waveform of the voltage V₁₃ across the incandescent bulb 13, and the waveform of the current I₁₃ flowing to the incandescent bulb 13. When the triac Tri1 switches from off to on, the voltage V_{I3} across the incandescent bulb 13 sharply rises, the current I₁₃ flowing to the incandescent bulb 13 also sharply rises, and the incandescent bulb 13 is lit. Since current then continues to flow to the incandescent bulb 13 while the triac Tri1 is on, the incandescent bulb 13 continues to be lit until the output voltage V₁ of the alternating-current power supply 1 reaches a value near 0 V.

FIGS. 21A through 21C show examples of the waveform of the voltage V₃ across the LED module 3 in the LED illumination system shown in FIG. 17. FIG. 21A shows the waveform of the voltage V₃ across the LED module 3 at a bright dimmer level, FIG. 21B shows the waveform of the voltage V₃ across the LED module 3 at a dark dimmer level, and FIG. 21C shows the waveform of the voltage V₃ across the LED module 3 at an intermediate dimmer level (a level between the bright dimmer level and the dark dimmer level).

In a case in which the bright dimmer level is set, after the triac Tri1 switches from off to on, and the LED module 3 is lit, when the voltage V₃ across the LED module 3 drops below the forward voltage V_{F} of the LED module 3, current no longer flows to the LED module 3, and the triac Tri1 switches off. The voltage V₃ across the LED module 3 therefore sharply decreases (see FIG. 21A).

FIG. 22A shows simulation waveforms of the voltage/current of each component of the LED illumination system shown in FIG. 17 in a case in which the bright dimmer level is set. FIG. 22A shows the waveform of the output voltage V₁ of the alternating-current power supply 1, the voltage V₃ across the LED module 3, and the current I₃ flowing to the LED module 3. FIG. 22A also shows the results of a simulation in which the knob of the semi-fixed resistor Rvar1 is set to the position for maximum light intensity of the LED module 3, i.e., the position at which the resistance value of the semi-fixed resistor Rvar1 is 0Ω. In FIG. 22A, switching on of the triac Tri1 and rising of the voltage V₃ across the LED module 3 occur when the phase is 53°. The light intensity of the LED module 3 proportional to the average current of the LED module 3, and can therefore be estimated from the average current of the LED module 3. The relationship between the average current of the LED module 3 and the resistance value of the semi-fixed resistor Rvar1 is as shown in FIG. 23. Assuming the light intensity of the LED module 3 to be 100% in a state in which the phase control dimmer 2 is not provided, the light intensity of the LED module 3 is 90.5% in the conditions under which the simulation results of FIG. 22A are obtained.

On the other hand, in the case in which the dark dimmer level is set, after the triac Tri1 switches from off to on, and the LED module 3 is lit, when the voltage V₃ across the LED module 3 drops below the forward voltage V_{F} of the LED module 3, current no longer flows to the LED module 3. However, because the phase shift capacitors C2 and C3 are provided in the phase control dimmer 2, current flows to the triac Tri1 from the capacitors C2 and C3, and the triac Tri1 does not switch off (see FIG. 21B).

FIG. 22B shows simulation waveforms of the voltage/current of each component of the LED illumination system shown in FIG. 17 in a case in which the dark dimmer level is set. FIG. 22B shows the waveform of the output voltage V₁ of the alternating-current power supply 1, the voltage V₃ across the LED module 3, and the current I₃ flowing to the LED module 3. FIG. 22B shows the results of a simulation in which the resistance value of the semi-fixed resistor Rvar1 is 150 kΩ. In FIG. 22B, switching on of the triac Tri1 and rising of the voltage V₃ across the LED module 3 occur when the phase is 141°. The light intensity of the LED module 3 is 0.71% in the conditions in which the simulation results of FIG. 22B are obtained.

For example, when the capacitance of the capacitor C2 is 100 nF, the resistance value of the resistor R1 is 5.6 kΩ, and the initial value of the voltage across the capacitor C2 is 141 V, the current flowing from the capacitor C2 takes approximately 900 μs to drop below the hold current (5 mA in this case) of the triac Tri1. Specifically, the holding time of the triac Tri1 by the capacitor C2 is approximately 900 μs. A waveform such as the one shown in FIG. 21A occurs in a case in which current stops flowing to the LED module 3 after 900 μs has elapsed since the triac Tri1 switched on, and a waveform such as the one shown in FIG. 21B occurs in a case in which current stops flowing to the LED module 3 within 900 μs. As shown in FIG. 21C, a waveform in which the waveform shown in FIG. 21A and the waveform shown in FIG. 21B are mixed occurs in a case in which conditions are exactly between those of the two waveforms, i.e., current stops flowing to the LED module 3 900 μs after the triac Tri1 switches on. When the state shown in FIG. 21C occurs, the amount of charge in the capacitor C2 and fluctuation of the time constants of the resistor R1 and capacitor C2 cause the current flowing to the LED module 3 to be unstable, the light flickers, and flickering occurs during low-level dimming.

FIG. 22C shows simulation waveforms of the voltage/current of each component of the LED illumination system shown in FIG. 17 in a case in which the intermediate dimmer level is set. FIG. 22C shows the waveform of the output voltage V₁ of the alternating-current power supply 1, the voltage V₃ across the LED module 3, and the current I₃ flowing to the LED module 3. FIG. 22C shows the results of a simulation in which the resistance value of the semi-fixed resistor Rvar1 is 135 kΩ. In FIG. 22C, the timing at which the triac Tri1 switches from off to on and the voltage V₃ across the LED module 3 rises alternates between a phase of 137° and a phase of 141°. The light intensity of the LED module 3 is 1.58% in the conditions in which the simulation results of FIG. 22C are obtained.

The problem of flickering during low-level dimming described above generally occurs when the light intensity of the LED module 3 is about 1 to 5%, but because there are various types of dimmers, the range of 1 to 5% is merely an approximation, and the problem of flickering during low-level dimming occurs as well at intensities other than 1 to 5%.

### SUMMARY OF THE INVENTION

An object of the present invention is to provide an LED drive circuit, a phase control dimmer, an LED illumination fixture, an LED illumination device, and an LED illumination system which are capable of reducing LED flicker during low-level dimming.

The LED drive circuit according to the present invention for achieving the abovementioned objects is an LED drive circuit in which an alternating voltage is input and an LED is driven, and which is capable of connecting to a phase control dimmer; and the LED drive circuit comprises a current extractor for continuing to allow current to flow into the phase control dimmer so that a phase control element inside the phase control dimmer does not switch off before the alternating voltage reaches 0 V after the phase control element inside the phase control dimmer switches on and the LED emits light.

The current extractor may begin operating when the value of a current flowing through a power supply feed line for feeding an LED drive current to the LED drops below a detection determination value.

A current detection circuit for detecting an overcurrent, or a voltage detection circuit for detecting an overvoltage may be provided, wherein the value of the current flowing through the power supply feed line for feeding an LED drive current to the LED is indirectly detected from the detection result of the current detection circuit or the voltage detection circuit.

The current extractor may operate also when the phase control element inside the phase control dimmer is off.

The current extractor may stop operating when the alternating voltage reaches 0 V after the start of operation of the current extractor.

The current extractor may stop operating when a predetermined time has elapsed after the start of operation of the current extractor.

The phase control dimmer according to the present invention for achieving the abovementioned objects is a phase control dimmer capable of connecting to an LED drive circuit in which an alternating voltage is input and an LED is driven; and the phase control dimmer comprises a phase control element; and a force-off unit for forcing the phase control element to switch off before the alternating voltage reaches 0 V after the phase control element switches on and the LED emits light.

The force-off unit may force the phase control element to switch off when the value of a current flowing through a power supply feed line for feeding an LED drive current to the LED drops below a detection determination value.

A current detection circuit for detecting an overcurrent, or a voltage detection circuit for detecting an overvoltage may be provided in the LED drive circuit, wherein the value of the current flowing through the power supply feed line for feeding an LED drive current to the LED is indirectly detected from the detection result of the current detection circuit or the voltage detection circuit.

The value of the current flowing through the power supply feed line for feeding an LED drive current to the LED may be indirectly detected from the detection result of a voltage detection circuit for detecting the alternating voltage.

The force-off unit may force the phase control element to switch off when the voltage value detected by the voltage detection circuit reaches a predetermined value higher than the forward voltage of the LED.

The LED illumination fixture according to the present invention for achieving the abovementioned objects comprises the LED drive circuit according to any of the aspects of the present invention described above, and an LED connected to the output side of the LED drive circuit.

The LED illumination fixture according to the present invention for achieving the abovementioned objects may comprise an LED; and an LED flicker reduction unit for reducing flickering of the LED due to switching off of a phase control element inside the phase control dimmer before an alternating voltage inputted to the phase control dimmer reaches 0 V after the phase control element inside the phase control dimmer switches on and the LED emits light.

The LED illumination device according to the present invention for achieving the abovementioned objects comprises the LED drive circuit according to any of the aspects of the present invention described above, or the LED illumination fixture according to any of the aspects of the present invention described above.

The LED illumination system according to the present invention for achieving the abovementioned objects comprises the LED illumination fixture according to any of the aspects of the present invention described above, or the LED illumination device according to the present invention as described above, and a phase control dimmer connected to the input side of the LED illumination fixture or the LED illumination device.

The LED illumination system according to the present invention for achieving the abovementioned objects may comprise the phase control dimmer according to any of the aspects of the present invention described above, connected to the input side of the LED illumination fixture or the LED illumination device.

Through the present invention, a state such as the one shown in FIG. 22C does not occur, and flickering during low-level dimming can therefore be reduced.

### DESCRIPTION OF THE DRAWINGS

FIG. 1A is a view showing the configuration of the LED illumination system according to a first embodiment of the present invention;

FIG. 1B is a view showing the configuration of the LED illumination system according to a second embodiment of the present invention;

FIG. 2 is a view showing the configuration of the LED illumination system according to a third embodiment of the present invention;

FIG. 3 is a view showing the configuration of the LED illumination system according to a fourth embodiment of the present invention;

FIG. 4 is a view showing the configuration of the LED illumination system according to a fifth embodiment of the present invention;

FIG. 5 is a view showing the voltage-current characteristic of the LED module;

FIG. 6 is a view showing the configuration of the LED illumination system according to a sixth embodiment of the present invention;

FIG. 7 is a view showing the configuration of the LED illumination system according to a seventh embodiment of the present invention;

FIG. 8A is a view showing a first modification of the LED drive circuit used in the LED illumination system according to the present invention;

FIG. 8B is a view showing a second modification of the LED drive circuit used in the LED illumination system according to the present invention;

FIG. 9 is a view showing a third modification of the LED drive circuit used in the LED illumination system according to the present invention;

FIG. 10 is a timing chart showing the voltage/current waveform of each component in a case in which the LED drive circuit shown in FIG. 9 is used in the LED illumination system according to the present invention;

FIG. 11 is a view showing a fourth modification of the LED drive circuit used in the LED illumination system according to the present invention;

FIG. 12 is a view showing a fifth modification of the LED drive circuit used in the LED illumination system according to the present invention;

FIG. 13 is a view showing a sixth modification of the LED drive circuit used in the LED illumination system according to the present invention;

FIG. 14 is a view showing the configuration of the LED illumination system according to an eighth embodiment of the present invention;

FIG. 15 is a view showing an example of the overall structure of the LED illumination fixture according to the present invention, the LED illumination device according to the present invention, and the LED illumination system according to the present invention;

FIG. 16 is a view showing another example of the overall structure of the LED illumination fixture according to the present invention;

FIG. 17 is a view showing an example of the conventional LED illumination system;

FIG. 18 is a view showing another example of the conventional LED illumination system;

FIG. 19 is a view showing an example of the configuration of an incandescent bulb illumination system;

FIG. 20 is a view showing an example of the voltage/current waveform of each component of the incandescent bulb illumination system shown in FIG. 19;

FIG. 21A is a view showing an example of the waveform of the voltage across the LED module in the LED illumination system shown in FIG. 17 in a case in which the bright dimmer level is set;

FIG. 21B is a view showing an example of the waveform of the voltage across the LED module in the LED illumination system shown in FIG. 17 in a case in which the dark dimmer level is set;

FIG. 21C is a view showing an example of the waveform of the voltage across the LED module in the LED illumination system shown in FIG. 17 in a case in which the intermediate dimmer level is set;

FIG. 22A is a simulation waveform diagram showing the voltage/current of each component of the LED illumination system shown in FIG. 17 in a case in which the bright dimmer level is set;

FIG. 22B is a simulation waveform diagram showing the voltage/current of each component of the LED illumination system shown in FIG. 17 in a case in which the dark dimmer level is set;

FIG. 22C is a simulation waveform diagram showing the voltage/current of each component of the LED illumination system shown in FIG. 17 in a case in which the intermediate dimmer level is set; and

FIG. 23 is a view showing the relationship between the average current of the LED module and the resistance value of the semi-fixed resistor.

### DESCRIPTION OF THE PREFERRED EMBODIMENTS

Embodiments of the present invention will be described hereinafter with reference to the drawings.

### First Embodiment

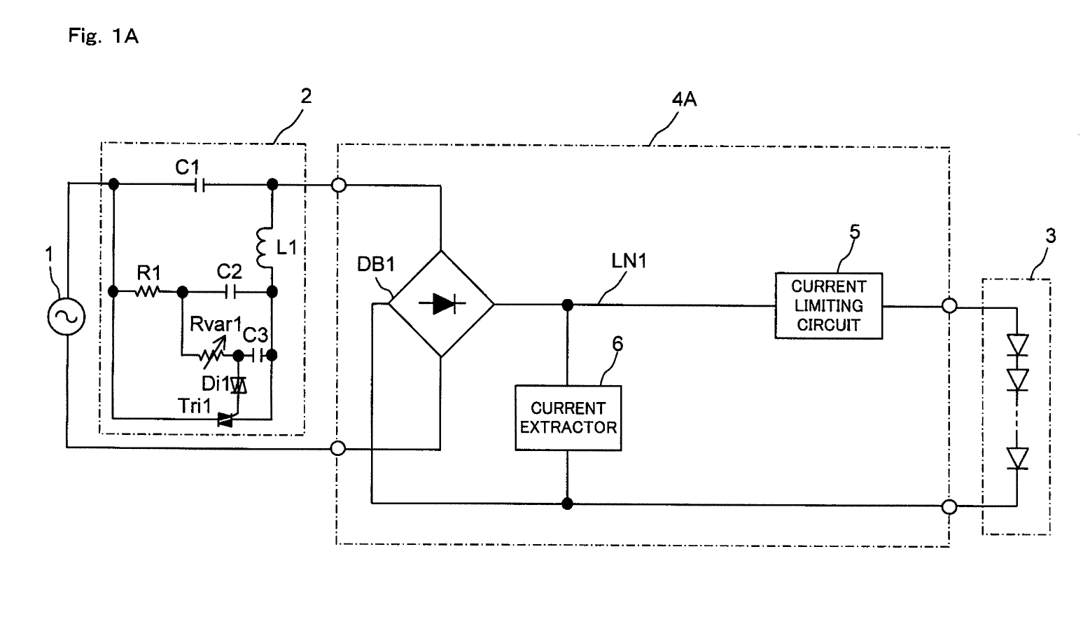

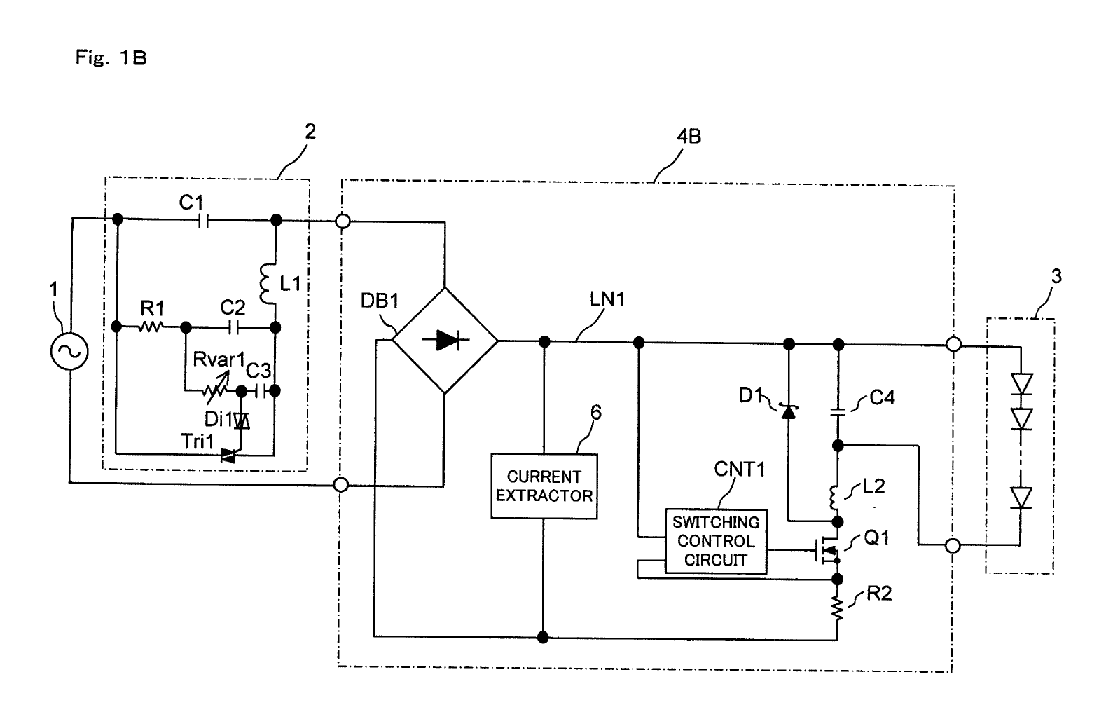

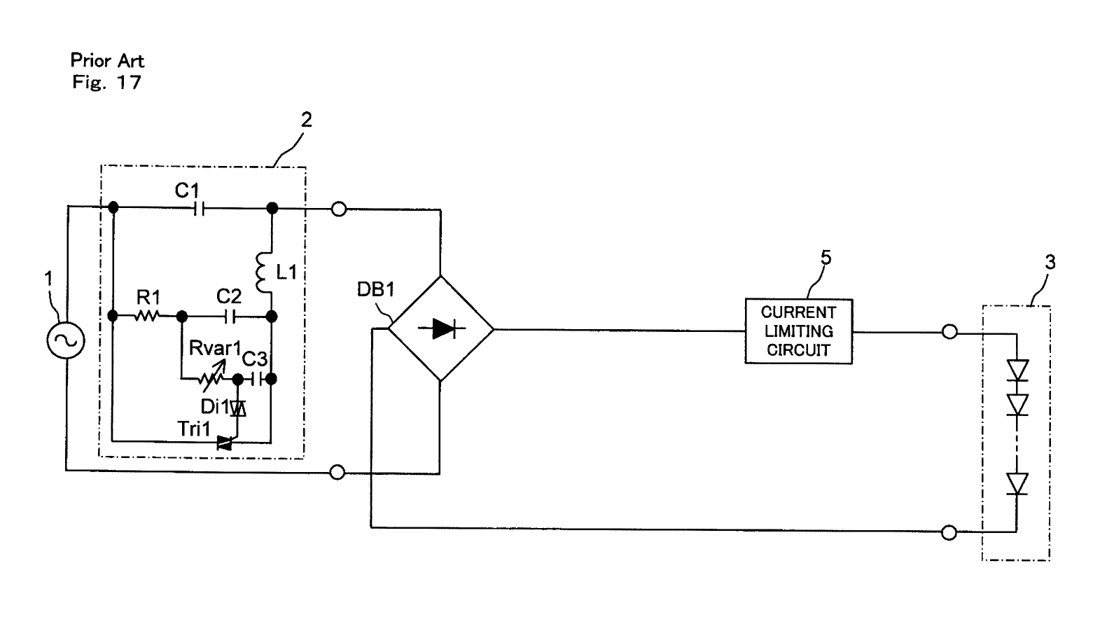

FIG. 1A shows the configuration of the LED illumination system according to a first embodiment of the present invention. The same reference symbols are used in FIG. 1A to refer to components that are the same as those in FIG. 17, and no detailed description thereof will be given. The LED illumination system according to the first embodiment of the present invention shown in FIG. 1A is provided with a phase control dimmer 2, an LED module 3, and an LED drive circuit 4A. The LED drive circuit 4A is an example of the LED drive circuit according to the present invention and is a direct-type (non-switching type) LED drive circuit, and has a diode bridge DB1, a current limiting circuit 5, and a current extractor 6. The current extractor 6 is provided between the output terminals of the diode bridge DB1, and extracts a current from a power supply feed line LN1 for feeding an LED drive current to the LED module 3 during operation. In the LED illumination system according to the first embodiment of the present invention shown in FIG. 1A, the phase control dimmer 2 is provided between an alternating-current power supply 1 and the input terminal of the LED drive circuit 4A, and the LED module 3 composed of one or more LED elements is provided between the output terminals of the LED drive circuit 4A.

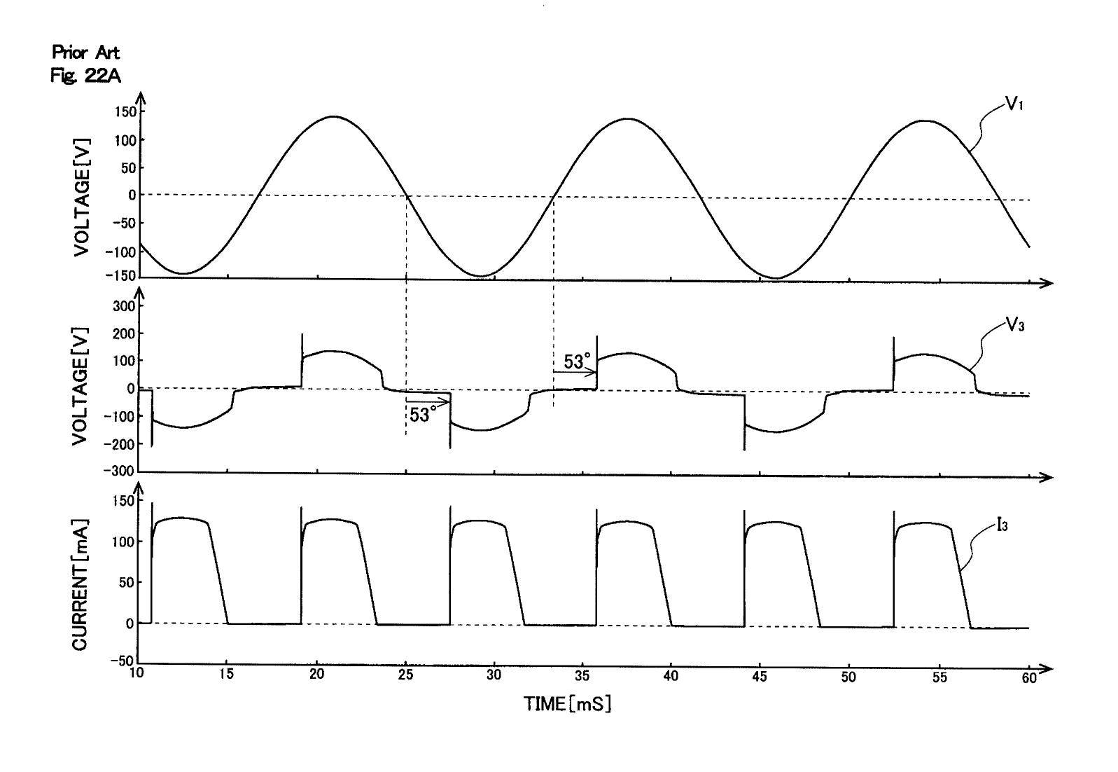

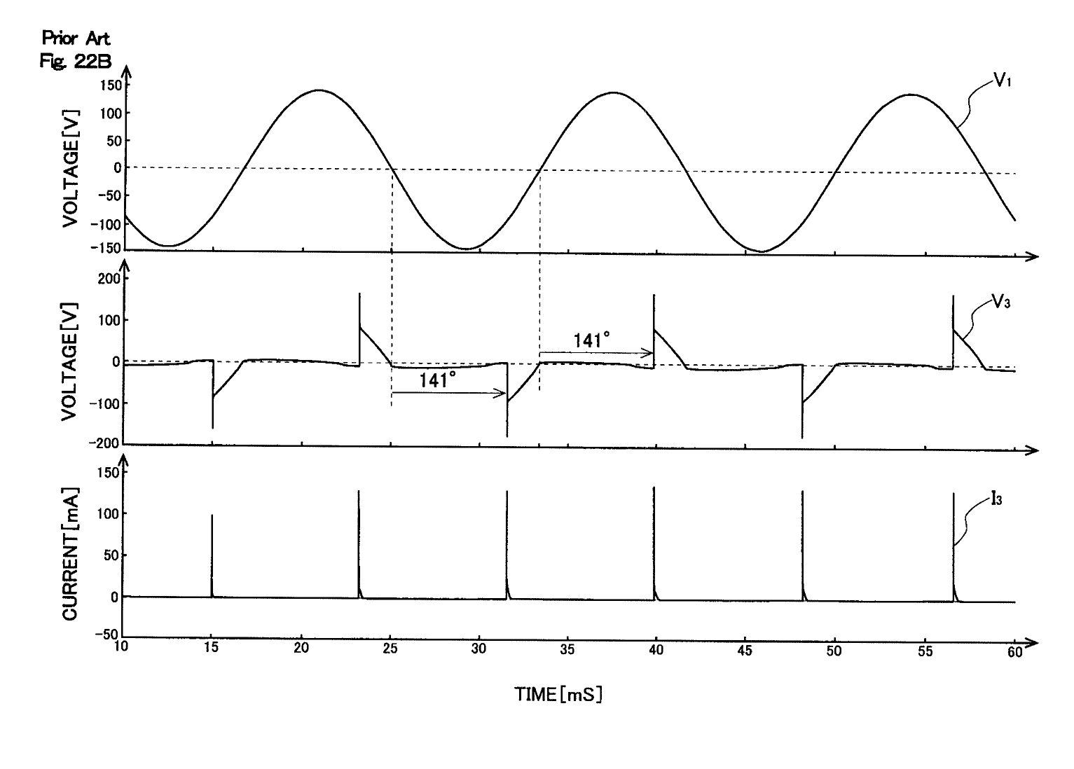

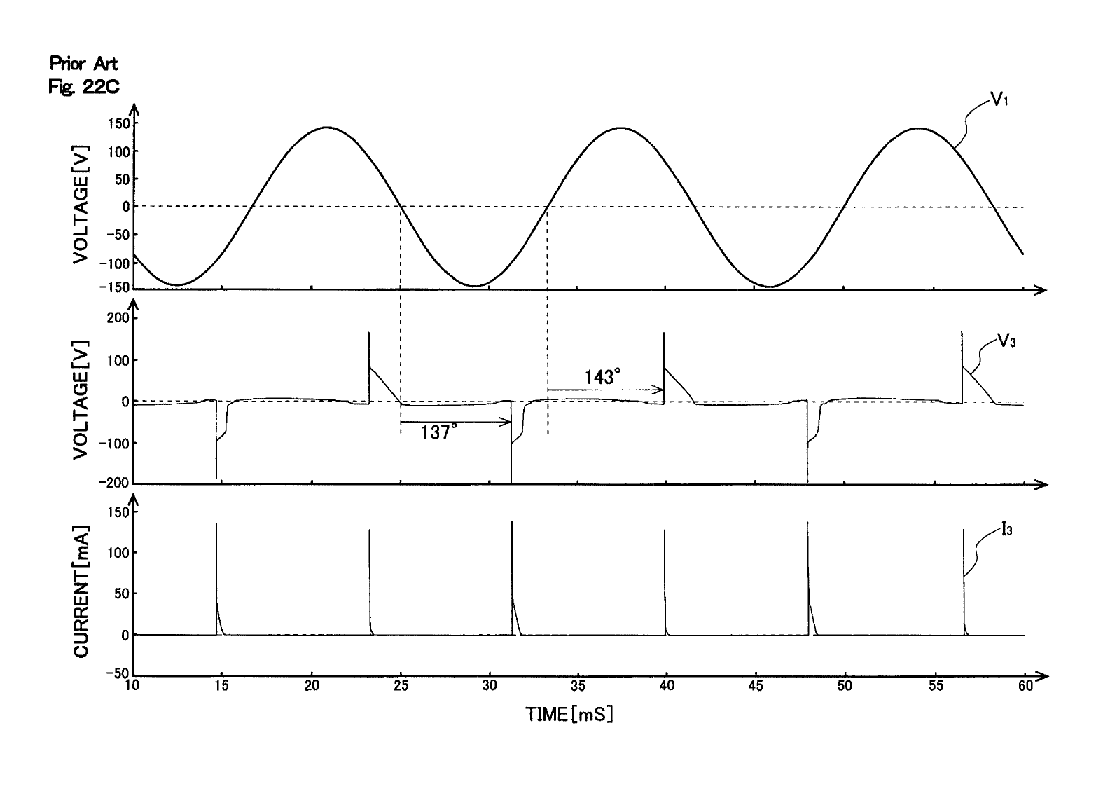

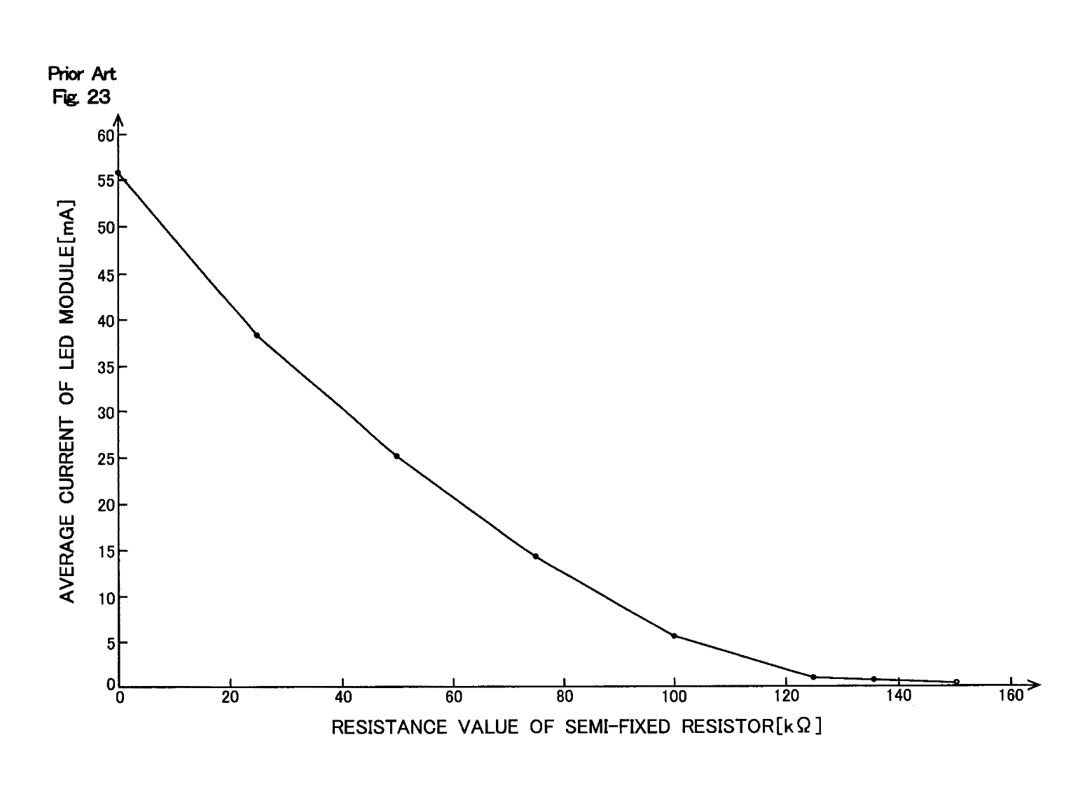

After a triac Tri1 inside the phase control dimmer 2 switches on and the LED module 3 emits light, the action of the current extractor 6 causes a current to flow to the triac Tri1 inside the phase control dimmer 2 and the triac Tri1 inside the phase control dimmer 2 does not switch off until the output voltage V1 of the alternating-current power supply 1 reaches 0 V. The output voltage V₁ of the alternating-current power supply 1 and the voltage V₃ across the LED module 3 therefore coincide, as shown in FIG. 22B. A state such as the one shown in FIG. 22C is thereby prevented, and flickering during low-level dimming can therefore be reduced.

### Second Embodiment

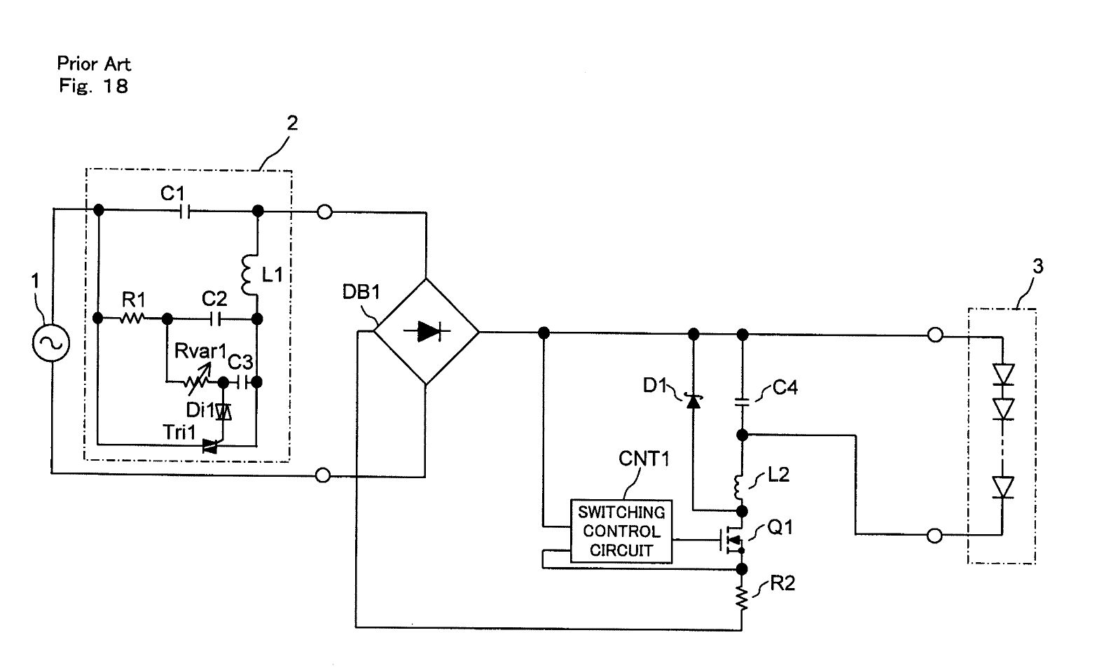

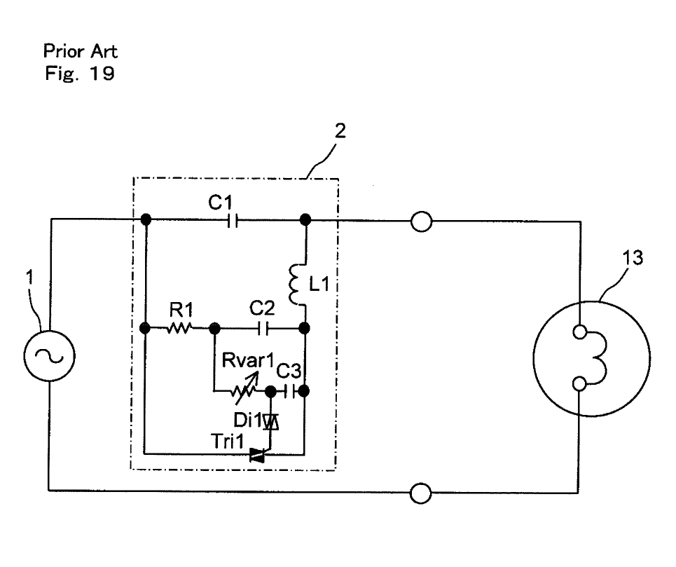

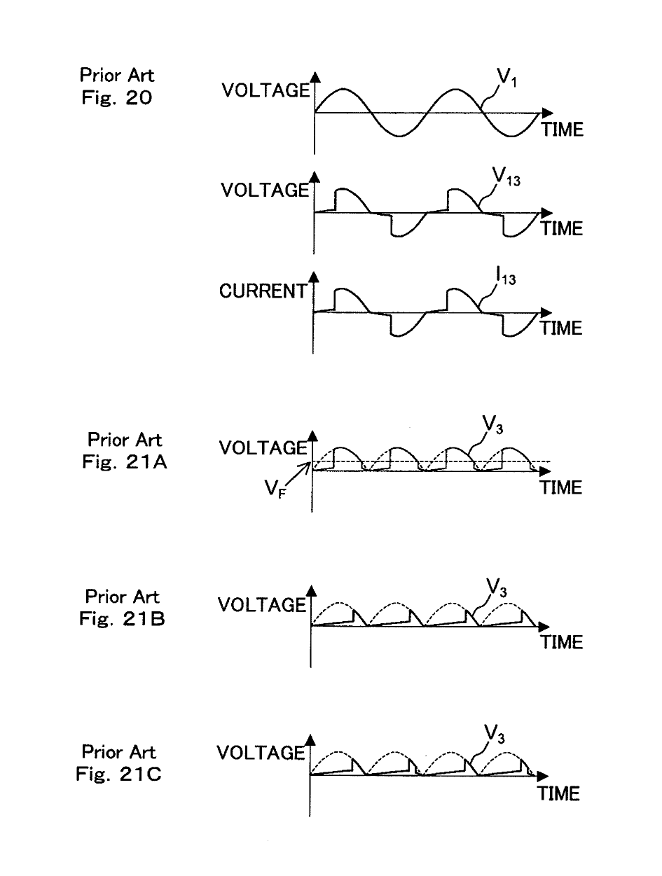

FIG. 1B shows the configuration of the LED illumination system according to a second embodiment of the present invention. The same reference symbols are used in FIG. 1B to refer to components that are the same as those in FIG. 18, and no detailed description thereof will be given. The LED illumination system according to the present invention shown in FIG. 1B is provided with a phase control dimmer 2, an LED module 3, and an LED drive circuit 4B. The LED drive circuit 4B is another example of the LED drive circuit according to the present invention, and is a switching-type LED drive circuit having a diode bridge DB1, a switching control circuit CNT1, a switching element Q1, a coil L2, a diode D1, a capacitor C4, a resistor R2, and a current extractor 6. The current extractor 6 is provided between the output terminals of the diode bridge DB1, and extracts a current from a power supply feed line LN1 for feeding an LED drive current to the LED module 3 during operation. In the LED illumination system according to the second embodiment of the present invention shown in FIG. 1B, the phase control dimmer 2 is provided between an alternating-current power supply 1 and the input terminal of the LED drive circuit 4B, and the LED module 3 composed of one or more LED elements is provided between the output terminals of the LED drive circuit 4B.

After a triac Tri1 inside the phase control dimmer 2 switches on and the LED module 3 emits light, the action of the current extractor 6 causes a current to flow to the triac Tri1 inside the phase control dimmer 2 and the triac Tri1 inside the phase control dimmer 2 does not switch off until the output voltage V1 of the alternating-current power supply 1 reaches 0 V. The output voltage V₁ of the alternating-current power supply 1 and the voltage V₃ across the LED module 3 therefore coincide, as shown in FIG. 22B. A state such as the one shown in FIG. 22C is thereby prevented, and flickering during low-level dimming can therefore be reduced.

### Third Embodiment

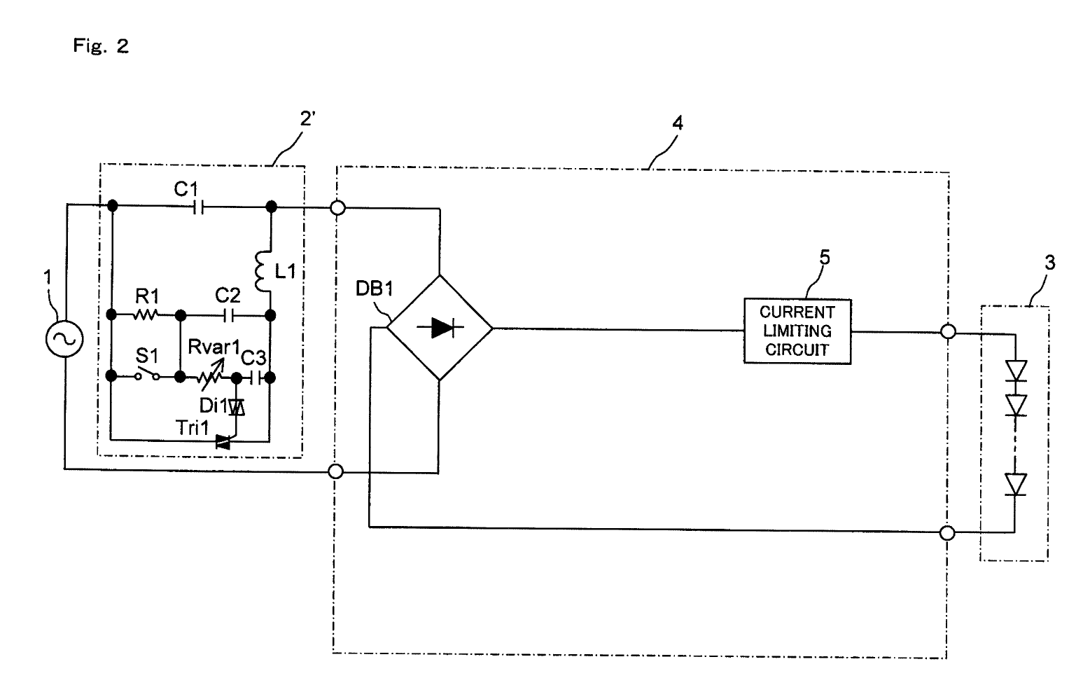

FIG. 2 shows the configuration of the LED illumination system according to a third embodiment of the present invention. The same reference symbols are used in FIG. 2 to refer to components that are the same as those in FIG. 17, and no detailed description thereof will be given. The LED illumination system according to the third embodiment of the present invention shown in FIG. 2 is provided with a phase control dimmer 2′, an LED module 3, and an LED drive circuit 4. The LED drive circuit 4 is a direct-type (non-switching type) LED drive circuit, and has a diode bridge DB1 and a current limiting circuit 5. In the LED illumination system according to the third embodiment of the present invention shown in FIG. 2, the phase control dimmer 2′ is provided between an alternating-current power supply 1 and the input terminal of the LED drive circuit 4, and the LED module 3 composed of one or more LED elements is provided between the output terminals of the LED drive circuit 4.

The phase control dimmer 2′ is formed by adding a switch S1 to the phase control dimmer 2 shown in FIG. 17. After the triac Tri1 inside the phase control dimmer 2′ switches on and the LED module 3 emits light, the capacitor C2 and the triac Tri1 are connected in parallel and the capacitor C2 is immediately discharged by the switching on of the switch S1 before the output voltage V₁ of the alternating-current power supply 1 reaches 0 V. The triac Tri1 inside the phase control dimmer 2′ therefore switches off, as shown in FIG. 22A. A state such as the one shown in FIG. 22C is thereby prevented, and flickering during low-level dimming can therefore be reduced.

### Fourth Embodiment

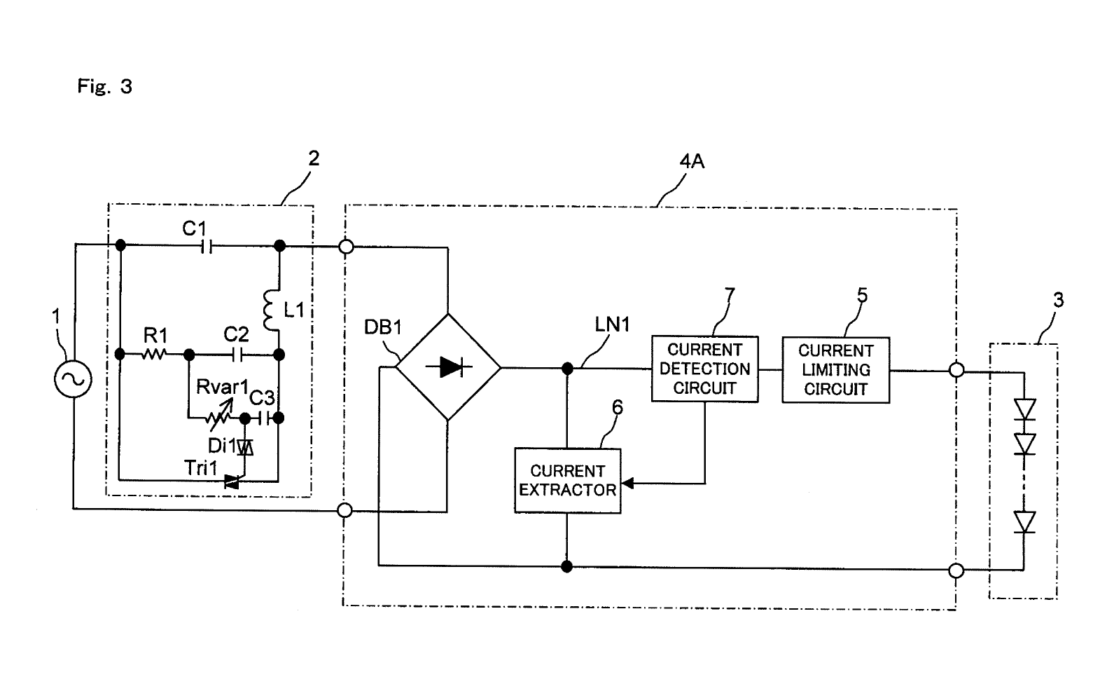

FIG. 3 shows the configuration of the LED illumination system according to a fourth embodiment of the present invention. The same reference symbols are used in FIG. 3 to refer to components that are the same as those in FIG. 1A, and no detailed description thereof will be given. The LED illumination system according to the fourth embodiment of the present invention shown in FIG. 3 is a specific example of the LED illumination system according to the first embodiment of the present invention shown in FIG. 1A.

In the LED illumination system according to the fourth embodiment of the present invention shown in FIG. 3, the LED drive circuit 4A has a current detection circuit 7. The current detection circuit 7 detects whether the value of the current flowing to the power supply feed line LN1 is below a detection determination value. The current extractor 6 begins operating when the current detection circuit 7 detects that the value of the current flowing to the power supply feed line LN1 is below the detection determination value.

### Fifth Embodiment

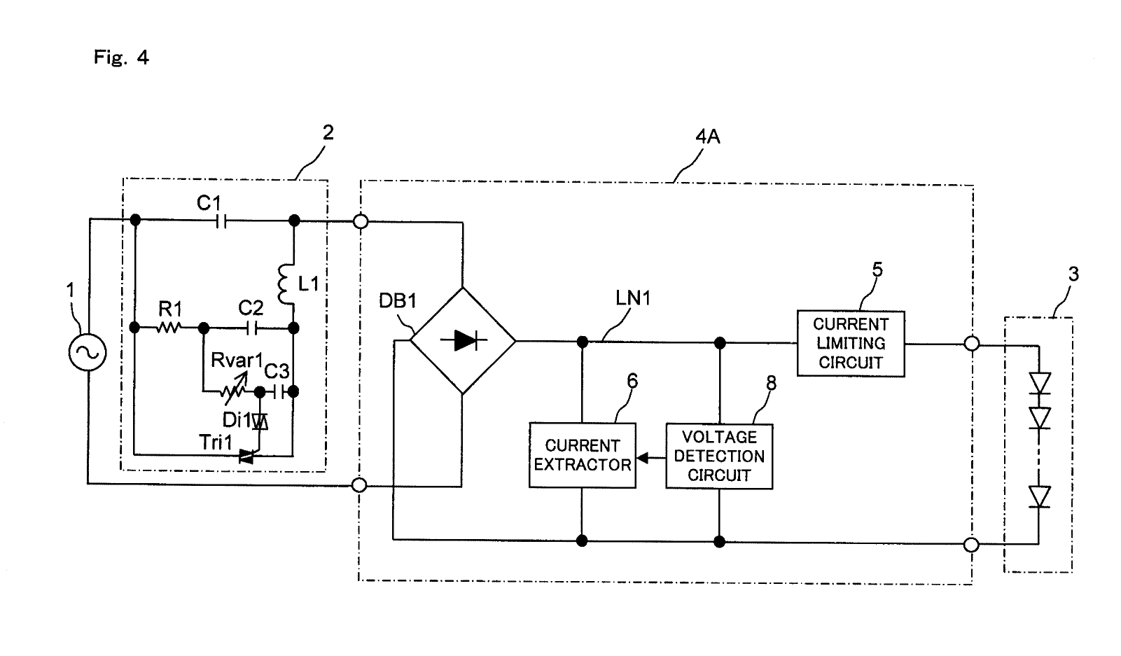

FIG. 4 shows the configuration of the LED illumination system according to a fifth embodiment of the present invention. The same reference symbols are used in FIG. 4 to refer to components that are the same as those in FIG. 1A, and no detailed description thereof will be given. The LED illumination system according to the fifth embodiment shown in FIG. 4 is another specific example of the LED illumination system according to the first embodiment of the present invention shown in FIG. 1A.

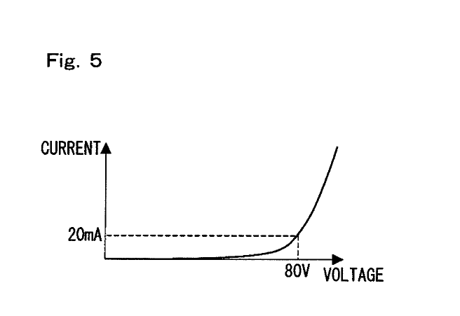

In the LED illumination system according to the fifth embodiment of the present invention shown in FIG. 4, the LED drive circuit 4A has a voltage detection circuit 8. The voltage detection circuit 8 detects the value of the voltage across the output terminals of the diode bridge DB1. The current extractor 6 begins operating when the value of the current flowing to the power supply feed line LN1 is below the detection determination value on the basis of the voltage value detected by the voltage detection circuit 8. In a case in which the voltage-current characteristic of the LED module 3 is as shown in FIG. 5, for example, when a voltage drop of 6 V occurs in the current limiting circuit 5 when the value of the current flowing to the power supply feed line LN1 (=current value of the LED module 3) is 20 mA, the voltage value detected by the voltage detection circuit 8 is 86 V.

### Sixth Embodiment

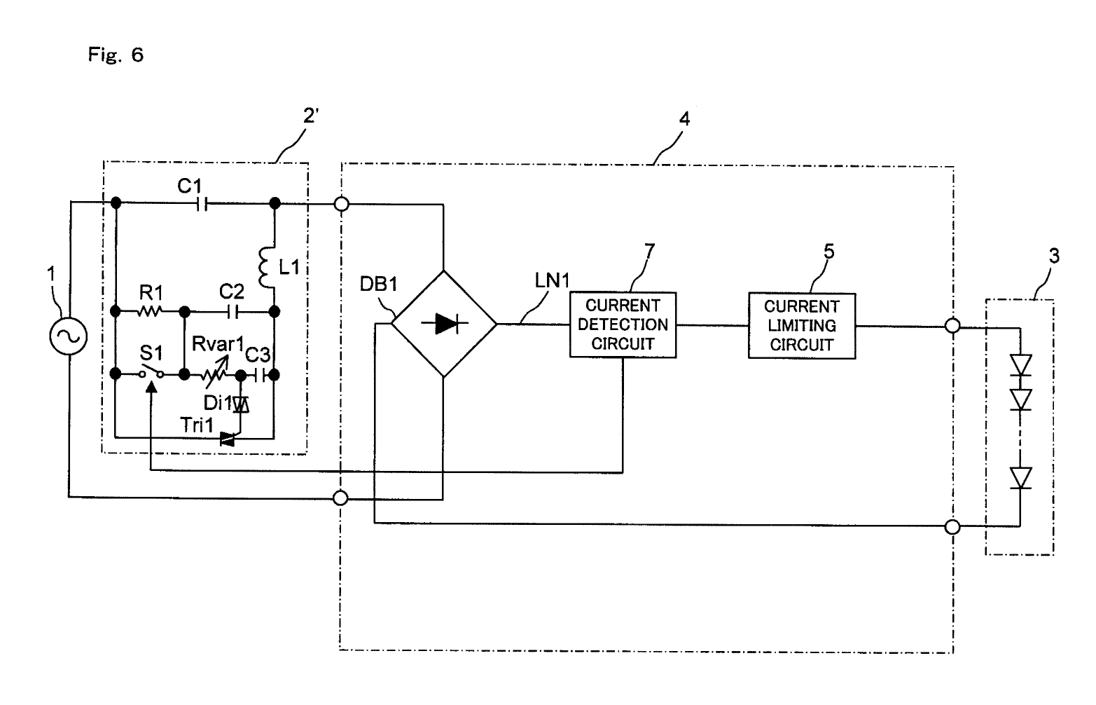

FIG. 6 shows the configuration of the LED illumination system according to a sixth embodiment of the present invention. The same reference symbols are used in FIG. 6 to refer to components that are the same as those in FIG. 2, and no detailed description thereof will be given. The LED illumination system according to the sixth embodiment of the present invention shown in FIG. 6 is a specific example of the LED illumination system according to the third embodiment of the present invention shown in FIG. 2.

In the LED illumination system according to the sixth embodiment of the present invention shown in FIG. 6, the LED drive circuit 4 has a current detection circuit 7. The current detection circuit 7 detects the value of the current flowing to the power supply feed line LN1. The current detection circuit 7 detects whether the value of the current flowing to the power supply feed line LN1 is below a detection determination value. The switch S1 inside the phase control dimmer T switches on when the current detection circuit 7 detects that the value of the current flowing to the power supply feed line LN1 has dropped below the detection determination value.

### Seventh Embodiment

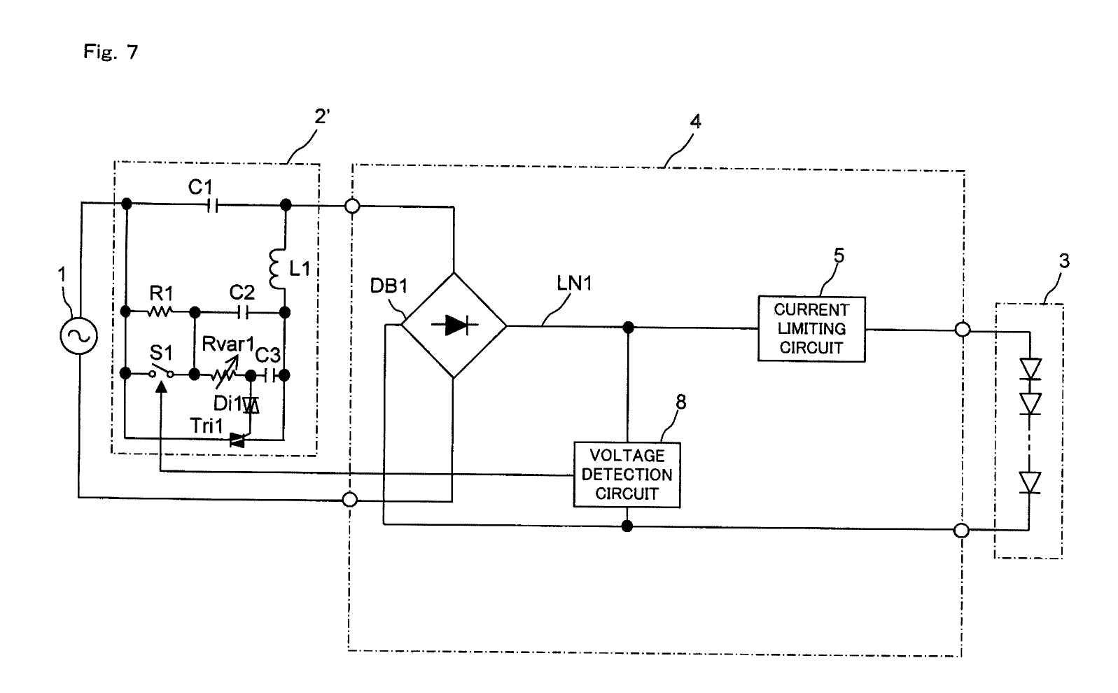

FIG. 7 shows the configuration of the LED illumination system according to a seventh embodiment of the present invention. The same reference symbols are used in FIG. 7 to refer to components that are the same as those in FIG. 2, and no detailed description thereof will be given. The LED illumination system according to the seventh embodiment shown in FIG. 7 is another specific example of the LED illumination system according to the third embodiment of the present invention shown in FIG. 2.

In the LED illumination system according to the seventh embodiment of the present invention shown in FIG. 7, the LED drive circuit 4 has a voltage detection circuit 8. The voltage detection circuit 8 detects the value of the voltage across the output terminals of the diode bridge DB1. The switch S1 switches on when the value of the current flowing to the power supply feed line LN1 is below the detection determination value on the basis of the voltage value detected by the voltage detection circuit 8. In a case in which the voltage-current characteristic of the LED module 3 is as shown in FIG. 5, when a voltage drop of 6 V occurs in the current limiting circuit 5 when the value of the current flowing to the power supply feed line LN1 (=current value of the LED module 3) is 20 mA, for example, the voltage value detected by the voltage detection circuit 8 is 86 V.

### First and Second Modifications of the LED Drive Circuit

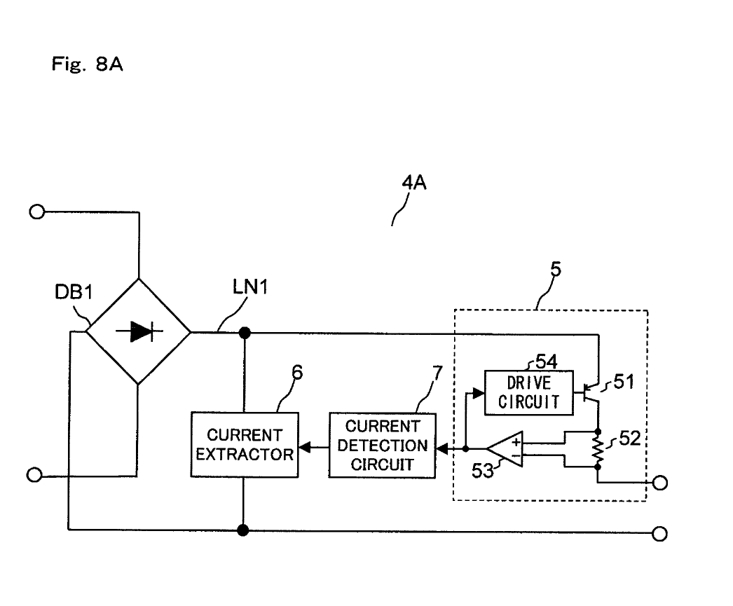

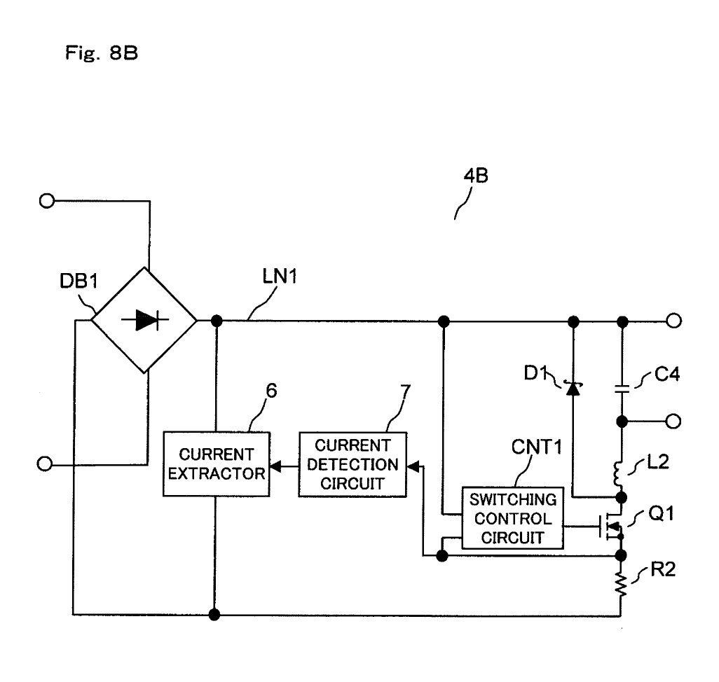

Rather than the current detection circuit 7 directly detecting the value of the current flowing to the power supply feed line LN1 as in the fourth embodiment of the present invention described above, a configuration may be adopted in which the voltage that occurs across the resistor 52 or R2 for controlling the current flowing through the LED module 3 (not shown in FIG. 8A or FIG. 8B) is utilized by the current detection circuit 7 to indirectly detect the value of the current flowing to the power supply feed line LN1, as in the direct-type (non-switching type) LED drive circuit 4A shown in FIG. 8A, or the switching-type LED drive circuit 4B shown in FIG. 8B. In the direct-type (non-switching type) LED drive circuit 4A shown in FIG. 8A, the current limiting circuit 5 is composed of a PNP transistor 51, a resistor 52 connected to a collector of the PNP transistor 51, a comparator 53 to which the voltage across the resistor 52 is inputted, and a drive circuit 54 for controlling the PNP transistor 51 in accordance with the output of the comparator 53.

The LED drive circuit 4 used in the sixth embodiment of the present invention described above may also be modified so that the voltage occurring across the resistor 52 for controlling the current flowing through the LED module 3 is utilized by the current detection circuit 7 to indirectly detect the value of the current flowing to the power supply feed line LN1, as in the direct-type (non-switching type) LED drive circuit 4A shown in FIG. 8A.

### Third Modification of the LED Drive Circuit

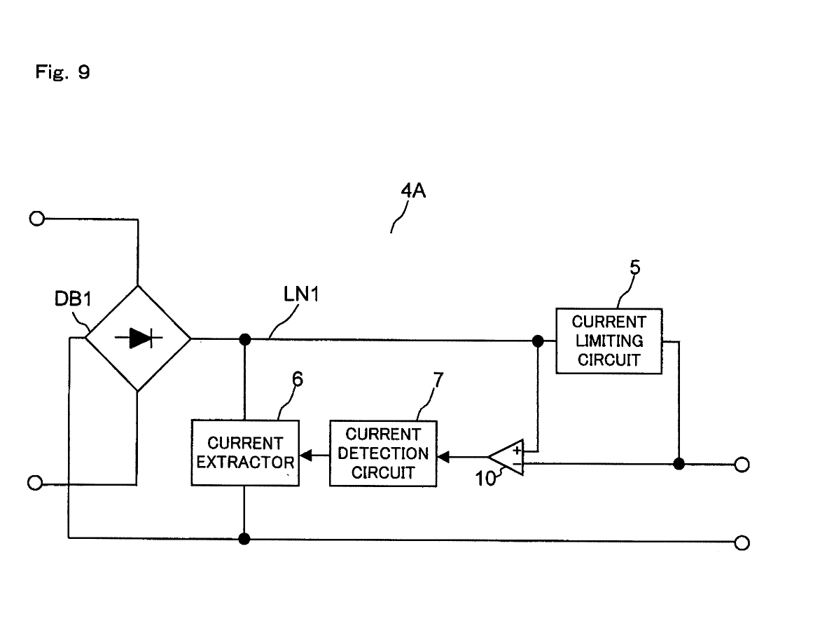

Rather than the current detection circuit 7 directly detecting the value of the current flowing to the power supply feed line LN1 as in the fourth embodiment of the present invention described above, a configuration may be adopted in which the voltage drop in the current limiting circuit 5 as detected by a comparator 10 is utilized by the current detection circuit 7 to indirectly detect the value of the current flowing to the power supply feed line LN1, as in the direct-type (non-switching type) LED drive circuit 4A shown in FIG. 9.

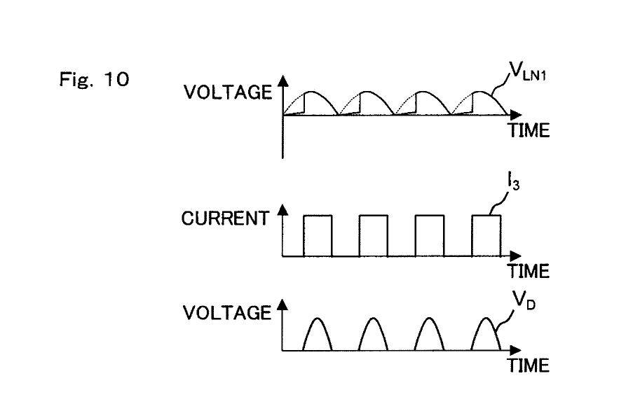

FIG. 10 is a timing chart showing the voltage V_{LN1} of the power supply feed line LN1, the current I₃ flowing through the LED module 3, and the voltage drop V_{D} in the current limiting circuit 5 in a case in which the direct-type (non-switching type) LED drive circuit 4A shown in FIG. 9 is used in the LED illumination system according to the present invention. As is apparent from FIG. 10, the voltage drop V_{D} in the current limiting circuit 5 decreases when current stops flowing in the LED module 3. Consequently, the current detection circuit 7 detects this reduction in the voltage drop V_{D} and thus indirectly detects the value of the current flowing to the power supply feed line LN1 (=value of the current flowing to the LED module 3).

The LED drive circuit 4 used in the sixth embodiment of the present invention described above may also be modified so that the voltage drop in the current limiting circuit 5 as detected by the comparator 10 is utilized by the current detection circuit 7 to indirectly detect the value of the current flowing to the power supply feed line LN1, as in the direct-type (non-switching type) LED drive circuit 4A shown in FIG. 9.

### Fourth Modification of the LED Drive Circuit

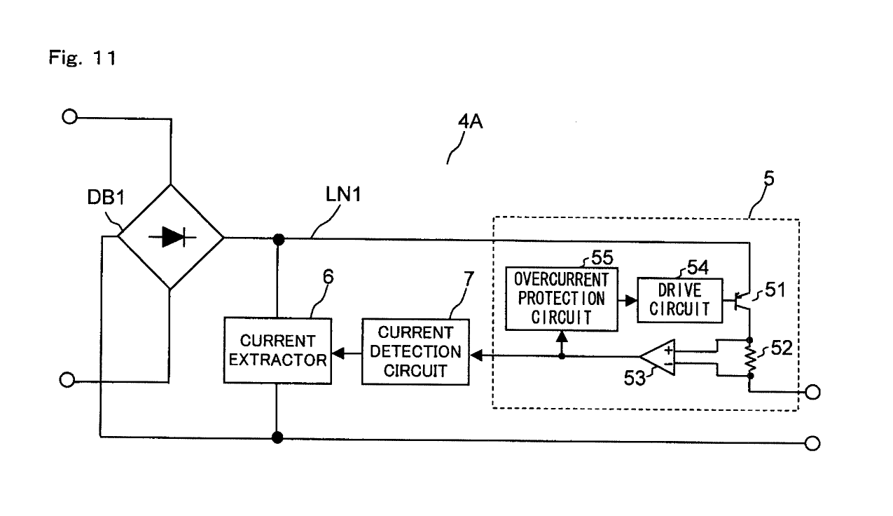

Rather than the current detection circuit 7 directly detecting the value of the current flowing to the power supply feed line LN1 as in the fourth embodiment of the present invention described above, a configuration may be adopted in which the voltage that occurs across the resistor 52 for controlling the current flowing through the LED module 3 (not shown in FIG. 11) is utilized by the current detection circuit 7 to indirectly detect the value of the current flowing to the power supply feed line LN1, as in the direct-type (non-switching type) LED drive circuit 4A shown in FIG. 11. In the direct-type (non-switching type) LED drive circuit 4A shown in FIG. 11, the current limiting circuit 5 has an overcurrent protection function, and is composed of a PNP transistor 51, a resistor 52 connected to a collector of the PNP transistor 51, a comparator 53 to which the voltage across the resistor 52 is inputted, a drive circuit 54 for driving the PNP transistor 51, and an overcurrent protection circuit 55 for issuing an instruction to the drive circuit 54 to switch off the PNP transistor 51 when the output of the comparator 53 exceeds a predetermined value.

Since the current detection circuit 7 is utilized for current detection in the overcurrent protection function, circuit size and cost can be reduced.

The LED drive circuit 4 used in the sixth embodiment of the present invention described above may also be modified so that the voltage occurring across the resistor 52 for controlling the current flowing through the LED module 3 is utilized by the current detection circuit 7 to indirectly detect the value of the current flowing to the power supply feed line LN1, as in the direct-type (non-switching type) LED drive circuit 4A shown in FIG. 11.

### Fifth Modification of the LED Drive Circuit

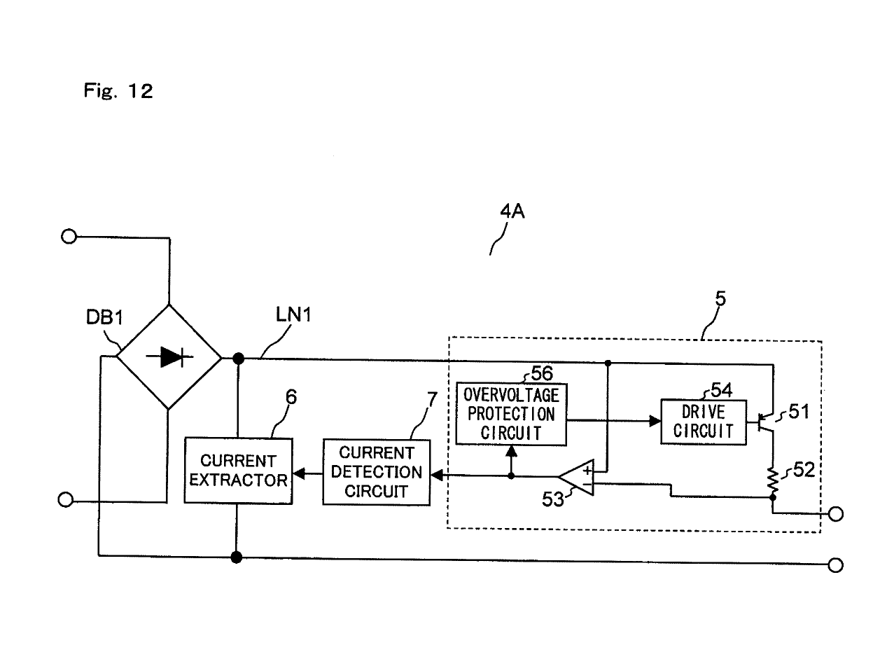

Rather than the current detection circuit 7 directly detecting the value of the current flowing to the power supply feed line LN1 as in the fourth embodiment of the present invention described above, a configuration may be adopted in which the voltage drop in the current limiting circuit 5 as detected by a comparator 53 is utilized by the current detection circuit 7 to indirectly detect the value of the current flowing to the power supply feed line LN1, as in the direct-type (non-switching type) LED drive circuit 4A shown in FIG. 12. In the direct-type (non-switching type) LED drive circuit 4A shown in FIG. 12, the current limiting circuit 5 has an overvoltage protection function, and is composed of a PNP transistor 51, a resistor 52 connected to a collector of the PNP transistor 51, a comparator 53 to which the voltage drop in the current limiting circuit 5 is inputted, a drive circuit 54 for driving the PNP transistor 51, and an overvoltage protection circuit 56 for issuing an instruction to the drive circuit 54 to switch off the PNP transistor 51 when the output of the comparator 53 exceeds a predetermined value.

Since the current detection circuit 7 is utilized for voltage detection in the overvoltage protection function, circuit size and cost can be reduced.

The LED drive circuit 4 used in the sixth embodiment of the present invention described above may also be modified so that the voltage drop in the current limiting circuit 5 as detected by the comparator 53 is utilized by the current detection circuit 7 to indirectly detect the value of the current flowing to the power supply feed line LN1, as in the direct-type (non-switching type) LED drive circuit 4A shown in FIG. 12.

### Sixth Modification of the LED Drive Circuit

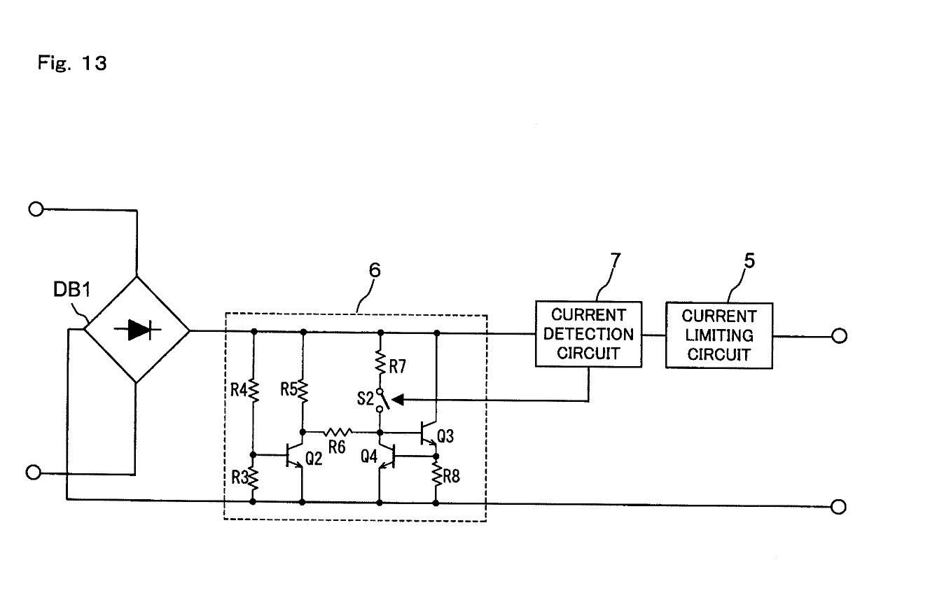

For example, in the LED illumination system according to the fourth embodiment of the present invention described above, the total impedance of the LED module 3 and the LED drive circuit 4A must be made lower than the impedance within the phase control dimmer 2 when the triac Tri1 of the phase control dimmer 2 is off. Since the total impedance of the LED module 3 and the LED drive circuit 4A is high in a case in which a plurality of LED elements is connected in series in the LED module 3, a low-impedance circuit is usually connected to the power supply feed line LN1 when the triac Tri1 is off. By using the current extractor 6 as a low-impedance circuit, as in the LED drive circuit 4A own in FIG. 13, the number of circuit elements can be reduced, and the size and cost of the LED drive circuit 4 can be reduced. In the LED drive circuit 4A shown in FIG. 13, the current extractor 6 is composed of resistors R4 through R8, NPN transistors Q2 through Q4, and a switch S2.

For example, when the voltage across the output terminals of the diode bridge DB1 is 30 V or lower, the NPN transistor Q2 switches off and the NPN transistor Q3 switches on, and a current determined by the voltage across the base emitter of the NPN transistor Q4 and the resistance value of the resistor R8 flows through the current extractor 6, and in a case in which the voltage across the output terminals of the diode bridge DB1 is higher than 30 V, the NPN transistor Q2 switches on and the NPN transistor Q3 switches off.

When the current value detected by the current detection circuit 7 is in a predetermined range, the switch S2 switches on and the NPN transistor Q3 switches on, whereby the current extractor 6 extracts current.

### Seventh Modification of the LED Drive Circuit

For example, in the LED drive circuit 4A used in the LED illumination system according to the fourth embodiment of the present invention described above, a configuration may be adopted in which current extraction is stopped when the voltage across the output terminals of the diode bridge DB1 reaches 0 V after the start of current extraction by the current extractor 6, in contrast with the sixth modification of the LED drive circuit described above. The current extractor 6 can thereby be operated to the minimum necessary extent, and current loss in the current extractor 6 can be suppressed. The comparator to which the voltage across the output terminals of the diode bridge DB1 is inputted, for example, can be used to detect the voltage across the output terminals of the diode bridge DB1.

### Eighth Modification of the LED Drive Circuit

For example, in the LED drive circuit 4A used in the LED illumination system according to the fourth embodiment of the present invention described above, a configuration may be adopted in which current extraction is stopped when a certain time has elapsed in excess of the triac maintenance time by phase shift capacitors C2, C3 after the start of current extraction by the current extractor 6, in contrast with the sixth modification of the LED drive circuit described above. The current extractor 6 can thereby be operated to the minimum necessary extent, and current loss in the current extractor 6 can be suppressed. A timer, for example, may be used as the means for measuring the passage of the certain time described above.

### Eighth Embodiment

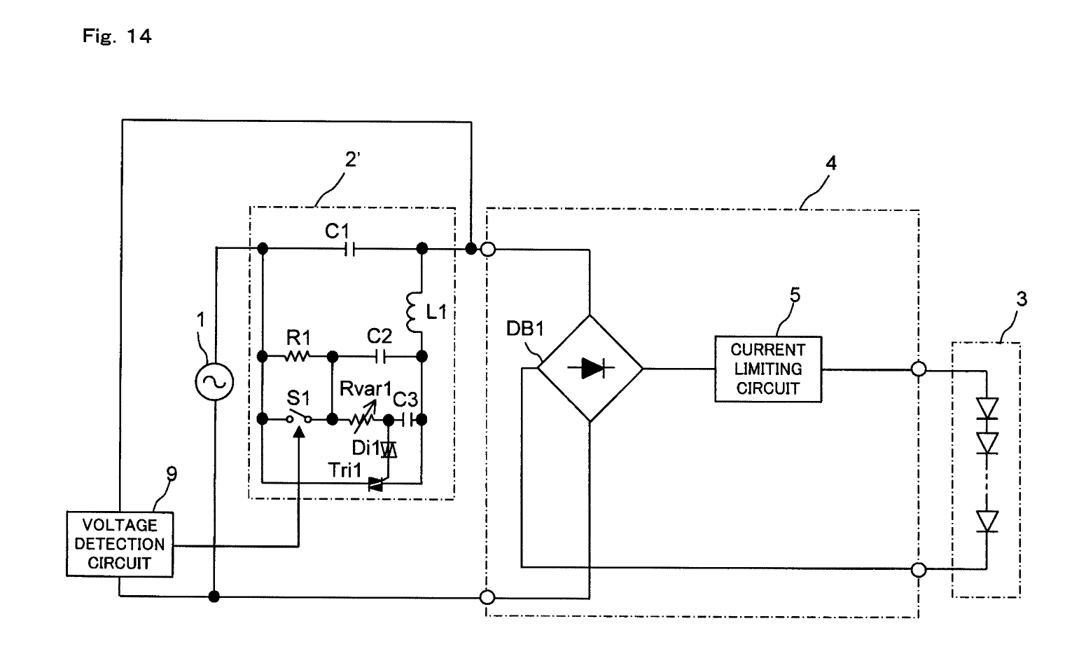

FIG. 14 shows the configuration of the LED illumination system according to an eighth embodiment of the present invention. The same reference symbols are used in FIG. 14 to refer to components that are the same as those in FIG. 2, and no detailed description thereof will be given. The LED illumination system according to the eighth embodiment of the present invention shown in FIG. 14 is a specific example of the LED illumination system according to the third embodiment of the present invention shown in FIG. 2.

The LED illumination system according to the eighth embodiment of the present invention shown in FIG. 14 is provided with a voltage detection circuit 9 for detecting the input voltage of the LED drive circuit 4. The switch S1 inside the phase control dimmer 2′ switches on when the voltage value detected by the voltage detection circuit 9 is in a predetermined range. The predetermined range is preferably a predetermined value higher than the forward voltage V_{F} of the LED module 3. When such a setting is adopted, the phase shift capacitor C2 is discharged, and the tin Tri1 can be forced off by the decrease in current of the LED module 3.

### Modifications

The input voltage of the LED drive circuit of the present invention or the phase control dimmer of the present invention is not limited to the Japanese domestic commercial power supply voltage of 100 V. By setting the circuit constant of the LED drive circuit of the present invention or the phase control dimmer of the present invention to the appropriate value, a foreign commercial power supply voltage or a stepped-down alternating-current voltage can be used as the input voltage of the LED drive circuit of the present invention or the phase control dimmer of the present invention.

A safer LED drive circuit can also be provided by adding a current fuse or other protective element to the LED drive circuit of the present invention.

The current extractor is provided to the output side of a diode bridge as a stage in front of the current limiting circuit in the configuration of the LED drive circuit according to the present invention described above, but the current extractor may also be provided to the input side of the diode bridge, or the current extractor may be provided to a stage after the current limiting circuit. However, in a case in which the current extractor is provided to a stage after the current limiting circuit, the current flowing to the current extractor must be set to a value lower than the current limiting value of the current limiting circuit.

The current limiting circuit 5 is connected to the anode side of the LED module 3 in the direct-type (non-switching type) LED drive circuit described above, but setting each circuit constant to the appropriate value enables the current limiting circuit 5 to be connected to the cathode side of the LED module 3 without problems.

In cases in which the current flowing to the LED module 3 has an adequate margin with respect to the rated current of the LED, dimmer operation and other operations are unaffected by the absence of a current limiting circuit 5.

The voltage inputted to the LED drive circuit of the present invention is not limited to a voltage based on a sine wave alternating-current voltage, and may be another alternating voltage. The voltage inputted to the phase control dimmer of the present invention is also not limited to a voltage based on a sine wave alternating-current voltage, and may be another alternating voltage.

The LED drive circuits described above are also all provided with a diode bridge, but the diode bridge is not an essential constituent element of the LED drive circuit of the present invention. In an example of a configuration in which a diode bridge is not provided, two LED modules having mutually different forward directions are provided, and a current limiting circuit, a current extractor, and an extraction timing adjuster are provided for each LED module. This configuration has advantages in that there is no need for a diode bridge, the power supply efficiency is somewhat enhanced by the fact that there is no need for the diode bridge, and the duty ratio of the LED drive current is half that of a system in which the LED is driven after full-wave rectification, thereby extending the life of the LED (meaning less reduction in luminous flux). This configuration has disadvantages, however, in that the number of LED elements is doubled, thereby increasing cost.

The embodiments and modifications described above can be combined in any manner and implemented insofar as the features thereof are not incompatible with each other.

### Led Illumination Fixture According to the Present Invention

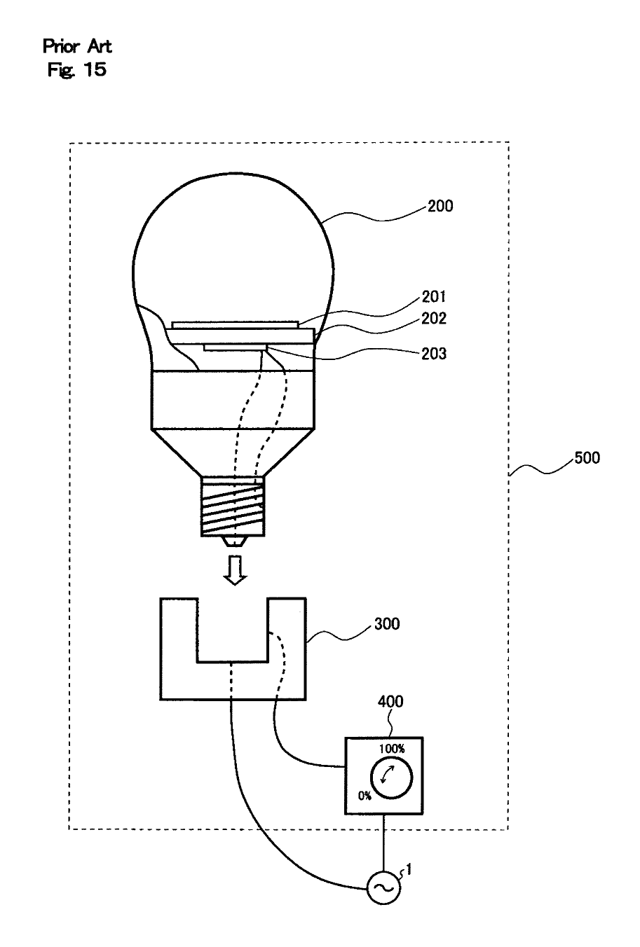

Lastly, the overall structure of the LED illumination fixture of the present invention will be described. FIG. 15 shows an example of the overall structure of the LED illumination fixture according to the present invention, the LED illumination device according to the present invention, and the LED illumination system according to the present invention. FIG. 15 shows a partial cut-away view of the compact self-ballasted LED illumination fixture 200 of the present invention. A housing or substrate 202, an LED module 201 composed of one or more LED elements provided to the front surface (facing the top of the bulb) of the housing or substrate 202, and a circuit 203 provided to the back surface (facing the bottom of the bulb) of the housing or substrate 202 are provided inside the compact self-ballasted LED illumination fixture 200 of the present invention. The examples of the LED drive circuit of the present invention described above, for example, may be used in the circuit 203. The circuit 203 is also not limited to the examples of the LED drive circuit of the present invention described above, and it is apparent that the circuit 203 may be any circuit provided at least with a circuit (LED flicker reduction unit) capable of reducing flickering or blinking of the LED that occurs as a result of the phase control element inside the phase control dimmer switching off before the alternating voltage inputted to the phase control dimmer reaches 0 V after the phase control element inside the phase control dimmer switches on and the LED emits light.

An LED illumination fixture mount 300 into which the compact self-ballasted LED illumination fixture 200 of the present invention is screwed, and a light controller (phase control dimmer) 400 are connected in series to the alternating-current power supply 1. The compact self-ballasted LED illumination fixture 200 of the present invention and the LED illumination fixture mount 300 constitute an LED illumination device (ceiling light, pendant light, kitchen light, recessed light, floor lamp, spotlight, foot light, or the like). The LED illumination system 500 of the present invention is formed by the compact self-ballasted LED illumination fixture 200 of the present invention, the LED illumination fixture mount 300, and the light controller 400. The LED illumination fixture mount 300 is disposed on an interior ceiling wall surface, for example, and the light controller 400 is disposed on an interior side wall surface, for example.

Since the compact self-ballasted LED illumination fixture 200 of the present invention can be attached to and detached from the LED illumination fixture mount 300, flickering or blinking of the LED that occurs when the hold current of the phase control element is inadequate because of voltage fluctuation of the power supply line in conjunction with oscillation of the output of the phase control dimmer can be reduced merely by replacing the incandescent bulb, fluorescent lamp, or other illumination fixture with the compact self-ballasted LED illumination fixture 200 of the present invention in an existing illumination device and illumination system in which a conventional incandescent bulb, fluorescent lamp, or the like was used.

In a case in which the compact self-ballasted LED illumination fixture 200 of the present invention is replaced by a common LED illumination fixture, the light controller 400 may be the phase control dimmer 2′ (see FIG. 2) of the present invention, for example.

FIG. 15 shows the appearance of the light controller 400 in a case in which the light controller 400 is the phase control dimmer shown in FIG. 1A, and the light controller 400 is configured so that the degree of dimming can be varied by using a volume knob. A configuration may also be adopted in which the degree of dimming can be varied by using a volume slider instead of a knob.

The light controller 400 is described above as being directly operable by a person by using a volume knob or volume slider, but this configuration is not limiting, and a person may also remotely operate the light controller 400 by using a remote control or other wireless signal. Specifically, remote operation is possible by providing a wireless signal receiver to the body of the light controller as the receiving side, and providing a transmitter body (e.g., a remote control transmitter, a mobile terminal, or the like) as the transmitting side with a wireless signal transmission unit for transmitting light control signals (e.g., a dimmer signal, a light on/off signal, and other signals) to the wireless signal receiver.

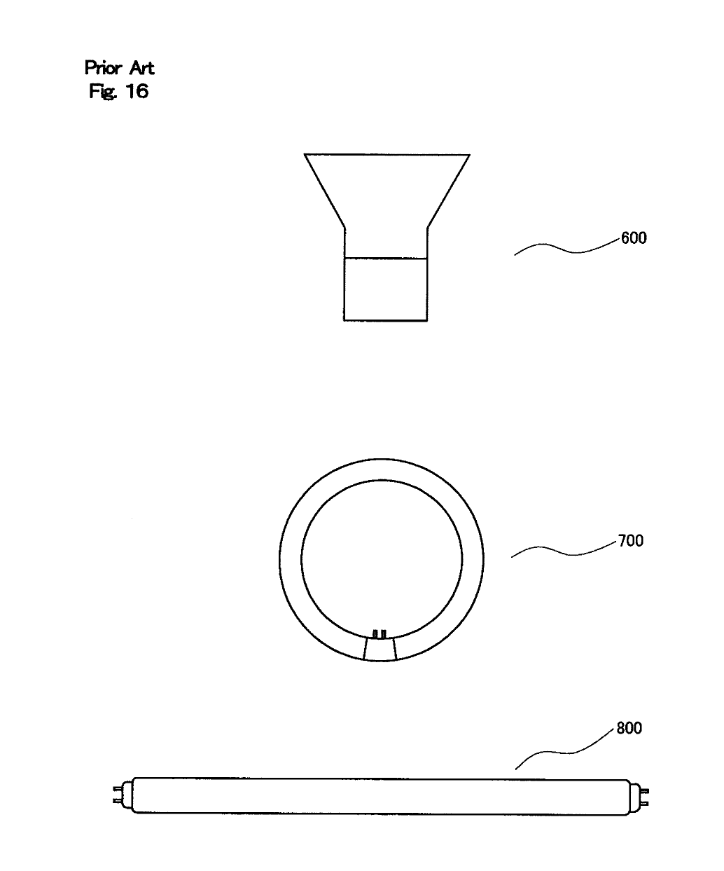

The LED illumination fixture of the present invention is not limited to a compact self-ballasted LED illumination fixture, and may be the lamp-type LED illumination fixture 600, the ring-type LED illumination fixture 700, or the straight tube-type LED illumination fixture 800 shown in FIG. 16. In any of these types of illumination fixtures, the LED illumination fixture of the present invention is provided inside with at least an LED and a circuit (LED flicker reduction unit) capable of reducing flickering or blinking of the LED that occurs as a result of the phase control element inside the phase control dimmer switching off before the alternating voltage inputted to the phase control dimmer reaches 0 V after the phase control element inside the phase control dimmer switches on and the LED emits light.

What is claimed is:

1. An LED drive circuit in which an alternating voltage is input and an LED is driven, and which is capable of connecting to a phase control dimmer; the LED drive circuit comprising:
a current extractor for continuing to allow current to flow into said phase control dimmer so that a phase control element inside said phase control dimmer does not switch off before said alternating voltage reaches 0 V after the phase control element inside said phase control dimmer switches on and said LED emits light.

2. The LED drive circuit according to claim 1, wherein
said current extractor begins operating when the value of a current flowing through a power supply feed line for feeding an LED drive current to said LED drops below a detection determination value.

3. The LED drive circuit according to claim 2, comprising:
a current detection circuit for detecting an overcurrent, or a voltage detection circuit for detecting an overvoltage; wherein
the value of the current flowing through the power supply feed line for feeding an LED drive current to said LED is indirectly detected from the detection result of said current detection circuit or said voltage detection circuit.

4. The LED drive circuit according to claim 1, wherein
said current extractor operates also when the phase control element inside said phase control dimmer is off.

5. The LED drive circuit according to claim 1, wherein
said current extractor stops operating when said alternating voltage reaches 0 V after the start of operation of the current extractor.

6. The LED drive circuit according to claim 1, wherein
said current extractor stops operating when a predetermined time has elapsed after the start of operation of the current extractor.

7. A phase control dimmer capable of connecting to an LED drive circuit in which an alternating voltage is input and an LED is driven; the phase control dimmer comprising:
a phase control element; and
a force-off unit for forcing said phase control element to switch off before said alternating voltage reaches 0 V after said phase control element switches on and said LED emits light.

8. The phase control dimmer according to claim 7, wherein
said force-off unit forces said phase control element to switch off when the value of a current flowing through a power supply feed line for feeding an LED drive current to said LED drops below a detection determination value.

9. The phase control dimmer according to claim 8, comprising:
a current detection circuit for detecting an overcurrent, or a voltage detection circuit for detecting an overvoltage in said LED drive circuit; wherein
the value of the current flowing through the power supply feed line for feeding an LED drive current to said LED is indirectly detected from the detection result of said current detection circuit or said voltage detection circuit.

10. The phase control dimmer according to claim 8, wherein
the value of the current flowing through the power supply feed line for feeding an LED drive current to said LED is indirectly detected from the detection result of a voltage detection circuit for detecting said alternating voltage.

11. The phase control dimmer according to claim 9, wherein
said force-off unit forces said phase control element to switch off when the voltage value detected by said voltage detection circuit reaches a predetermined value higher than the forward voltage of said LED.

12. The phase control dimmer according to claim 10, wherein
said force-off unit forces said phase control element to switch off when the voltage value detected by said voltage detection circuit reaches a predetermined value higher than the forward voltage of said LED.

13. An LED illumination fixture comprising:
an LED drive circuit; and
an LED connected to the output side of said LED drive circuit;
wherein
said LED drive circuit is
an LED drive circuit in which an alternating voltage is input and an LED is driven, and which is capable of connecting to a phase control dimmer; the LED drive circuit comprising:
a current extractor for continuing to allow current to flow into said phase control dimmer so that a phase control element inside said phase control dimmer does not switch off before said alternating voltage reaches 0 V after the phase control element inside said phase control dimmer switches on and said LED emits light.

14. An LED illumination fixture comprising:
an LED; and
an LED flicker reduction unit for reducing flickering of said LED due to switching off of a phase control element inside said phase control dimmer before an alternating voltage inputted to said phase control dimmer reaches 0 V after the phase control element inside the phase control dimmer switches on and said LED emits light.

15. An LED illumination device comprising:
an LED drive circuit;
wherein
said LED drive circuit is
an LED drive circuit in which an alternating voltage is input and an LED is driven, and which is capable of connecting to a phase control dimmer; the LED drive circuit comprising:
a current extractor for continuing to allow current to flow into said phase control dimmer so that a phase control element inside said phase control dimmer does not switch off before said alternating voltage reaches 0 V after the phase control element inside said phase control dimmer switches on and said LED emits light.

16. An LED illumination device comprising:
an LED illumination fixture;
wherein
said LED illumination fixture is
an illumination fixture comprising:
an LED drive circuit; and
an LED connected to the output side of said LED drive circuit;
wherein
said LED drive circuit is
an LED drive circuit in which an alternating voltage is input and an LED is driven, and which is capable of connecting to a phase control dimmer; the LED drive circuit comprising:
a current extractor for continuing to allow current to flow into said phase control dimmer so that a phase control element inside said phase control dimmer does not switch off before said alternating voltage reaches 0 V after the phase control element inside said phase control dimmer switches on and said LED emits light.

17. An LED illumination device comprising:
an LED illumination fixture;
wherein
said LED illumination fixture is
an illumination fixture comprising:
an LED; and
an LED flicker reduction unit for reducing flickering of said LED due to switching off of a phase control element inside said phase control dimmer before an alternating voltage inputted to said phase control dimmer reaches 0 V after the phase control element inside the phase control dimmer switches on and said LED emits light.

18. An LED illumination system comprising:
an LED illumination fixture; and
a phase control dimmer connected to the input side of the LED illumination fixture;
wherein
said LED illumination fixture is an illumination fixture comprising:
an LED drive circuit; and
an LED connected to the output side of said LED drive circuit;
wherein
said LED drive circuit is
an LED drive circuit in which an alternating voltage is input and an LED is driven, and which is capable of connecting to a phase control dimmer; the LED drive circuit comprising:
a current extractor for continuing to allow current to flow into said phase control dimmer so that a phase control element inside said phase control dimmer does not switch off before said alternating voltage reaches 0 V after the phase control element inside said phase control dimmer switches on and said LED emits light.

19. An LED illumination system comprising:
an LED illumination fixture; and
a phase control dimmer connected to the input side of the LED illumination fixture;
wherein
said LED illumination fixture is
an illumination fixture comprising:
an LED; and
an LED flicker reduction unit for reducing flickering of said LED due to switching off of a phase control element inside said phase control dimmer before an alternating voltage inputted to said phase control dimmer reaches 0 V after the phase control element inside the phase control dimmer switches on and said LED emits light.

20. An LED illumination system comprising:
an LED illumination device; and
a phase control dimmer connected to the input side of the LED illumination device;
wherein
said LED illumination device is
an LED illumination device comprising:
an LED drive circuit;
wherein
said LED drive circuit is
an LED drive circuit in which an alternating voltage is input and an LED is driven, and which is capable of connecting to a phase control dimmer; the LED drive circuit comprising:
a current extractor for continuing to allow current to flow into said phase control dimmer so that a phase control element inside said phase control dimmer does not switch off before said alternating voltage reaches 0 V after the phase control element inside said phase control dimmer switches on and said LED emits light.

21. An LED illumination system comprising:
an LED illumination device; and
a phase control dimmer connected to the input side of the LED illumination device;
wherein
said LED illumination device is
an LED illumination device comprising:
an LED illumination fixture;
wherein
said LED illumination fixture is
an illumination fixture comprising:
an LED drive circuit; and
an LED connected to the output side of said LED drive circuit;
wherein
said LED drive circuit is
an LED drive circuit in which an alternating voltage is input and an LED is driven, and which is capable of connecting to a phase control dimmer; the LED drive circuit comprising:
a current extractor for continuing to allow current to flow into said phase control dimmer so that a phase control element inside said phase control dimmer does not switch off before said alternating voltage reaches 0 V after the phase control element inside said phase control dimmer switches on and said LED emits light.

22. An LED illumination system comprising:
an LED illumination device; and
a phase control dimmer connected to the input side of the LED illumination device;
wherein
said LED illumination device is
an LED illumination device comprising:
an LED illumination fixture;
wherein
said LED illumination fixture is
an illumination fixture comprising:
an LED; and
an LED flicker reduction unit for reducing flickering of said LED due to switching off of a phase control element inside said phase control dimmer before an alternating voltage inputted to said phase control dimmer reaches 0 V after the phase control element inside the phase control dimmer switches on and said LED emits light.

23. An LED illumination system comprising:
a phase control dimmer connected to the input side of an LED illumination fixture or an LED illumination device;
wherein
said phase control dimmer is
a phase control dimmer capable of connecting to an LED drive circuit in which an alternating voltage is input and an LED is driven; the phase control dimmer comprising:
a phase control element; and
a force-off unit for forcing said phase control element to switch off before said alternating voltage reaches 0 V after said phase control element switches on and said LED emits light.
